(19) United States
(12) Patent Application Publication
(10) Pub. No.: US 2026/0086782 A1
(43) Pub. Date: Mar. 26, 2026

(54) HARDWARE CODE GENERATION FROM MULTIMEDIA SPECIFICATION DOCUMENTS

(71) Applicant: NVIDIA Corp., Santa Clara, CA (US)

(72) Inventors: Zhongzhi Yu, Atlanta, GA (US); Mingjie Liu, Austin, TX (US); Haoxing Ren, Austin, TX (US)

(73) Assignee: NVIDIA Corp., Santa Clara, CA (US)

(21) Appl. No.: 19/340,650

(22) Filed: Sep. 25, 2025

Related U.S. Application Data
(60) Provisional application No. 63/699,742, filed on Sep. 26, 2024.

(51) Int. Cl. G06F 8/35

(52) U.S. Cl. CPC G06F 8/35

(57) ABSTRACT

Mechanisms to transform a multimodal hardware specification document into register-transfer level (RTL) code by configuring a large language model into multiple agents to transform the hardware specification document into a structured implementation plan comprising a sequence of hardware functions, configuring the large language model to apply progressive coding and prompt optimization to sequentially transform the hardware functions into low-level program code through a plurality of progressively lower-level code generation stages, and transforming the low-level program code of the hardware functions into the RTL code through a code optimizer and high-level synthesis tool.

### CROSS REFERENCE TO RELATED APPLICATIONS

This application claims priority and benefit under 35 U.S.C. 119 (e) to U.S. application Ser. No. 63/699,742, “Hardware Code Generation from Complex Specification Documentation via Advanced LLM-Agent Systems”, filed on Sep. 26, 2024, the contents of which are incorporated herein by reference in their entirety.

### BACKGROUND

Conventional approaches to generating hardware code with large language models may be broadly classified into two approaches, each with its own limitations. The first approach revolves around generating simple functions using carefully crafted, concise natural language prompts. This approach may not account for realities of hardware development in which the target functions are complex and the instructions are not straightforward. Consequently, developments in this area tend to not translate effectively to practical use cases for hardware engineers.

The second approach utilizes large language models as human assistants in the development of more complex hardware code. This approach involves a high degree of human involvement, limiting its impact on development efficiency. In this approach, humans are responsible for interpreting the documentation, drafting implementation plans, and designing prompts for the large language models to generate code. Afterward, the humans review and debug the generated code to ensure correctness. Due to the extensive human effort required, this approach falls short of substantially improving hardware development efficiency or reducing the workload of engineers.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a conventional approach to hardware code generation.

FIG. 2 depicts an embodiment of a system configured to transform complex, unstructured hardware specification documents into register-transfer level (RTL) code.

FIG. 3 depicts an exemplary hardware specification document.

FIG. 4 depicts an embodiment of an iterative understanding and reasoning component configured to transform a hardware specification document into a structured, implementation-ready plan.

FIG. 5 depicts an embodiment of a progressive coding and prompt optimization component configured to receive an implementation plan from the understanding and reasoning component and to generate executable code for each sub-function of the implementation plan in sequence.

FIG. 6 depicts an exemplary implementation-plan entry schema consumed and transformed by the progressive coding and prompt optimization component.

FIG. 7 depicts an adaptive reflection component in one embodiment.

FIG. 8 depicts a code optimization and conversion component in one embodiment.

FIG. 9 depicts a parallel processing unit in accordance with one embodiment.

FIG. 10 depicts a general processing cluster in accordance with one embodiment.

FIG. 11 depicts a memory partition unit in accordance with one embodiment.

FIG. 12 depicts a streaming multiprocessor in accordance with one embodiment.

FIG. 13 depicts a processing system in accordance with one embodiment.

FIG. 14 depicts an exemplary processing system in accordance with another embodiment.

### DETAILED DESCRIPTION

In a typical hardware development process, engineers are tasked with translating detailed specifications into functional hardware code. Disclosed herein are embodiments of an agent system utilizing large language models (LLMs) that generate hardware code directly from complex specification documents with greatly reduced human intervention over conventional approaches.

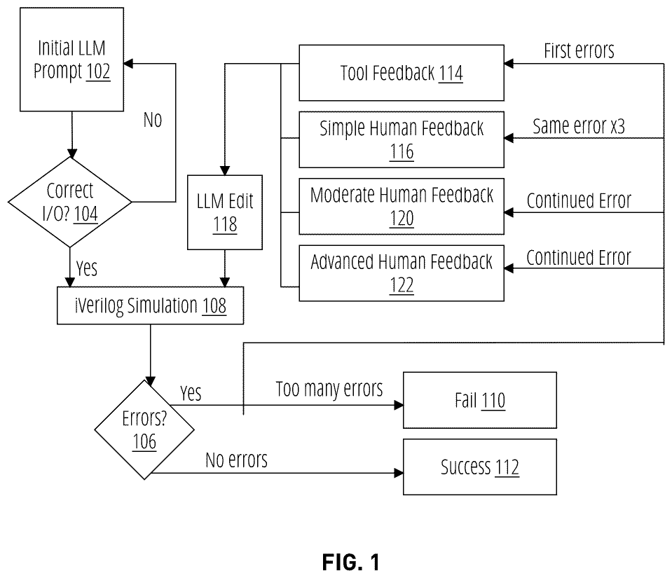

FIG. 1 depicts one conventional approach to hardware code generation. This approach relies on a highly skilled human engineer and large language model operator to understand, analysis, and decompose the hardware algorithm to implement. The human operator designs prompts for each hardware sub-function and passes these prompts to the large language model. The human operator analyzes the large language model output. If the output is erroneous, incomplete, or inefficient, the human operator either fixes the output themselves or designs a prompt to the large language model to regenerate improved output.

A large language model is provided with an initial prompt to generate hardware code for a sub-function of the hardware implementation plan (action 102). The large language model generates an output in response to the initial prompt. This output is checked for correctness (decision 104). If the output does not represent a correct hardware coding of the sub-function, the prompt to the large language model is modified by the human operator and resubmitted to generate revised output. If the output represents a sufficiently correct hardware coding of the sub-function, the generated hardware code is simulated (action 108).

The simulation is checked for errors (decision 106). If unacceptable errors result from the simulation, and cannot be successfully repaired, the hardware code generation for the sub-function reaches a fail state 110. Otherwise the hardware code generation for the sub-function reaches a success state 112 and the process moves on to generation of hardware code for the next sub-function of the hardware implementation plan.

Amelioration of errors resulting from the simulation may be attempted by first providing description/characterization of the errors from the simulation tool along with a prompt to the large language model (action 114). The large language model generates revised hardware code output from these inputs (action 118) and the revised hardware code is simulated. This process may repeat if errors continue to result from the simulation, with progressively greater amounts of human input to the large language model (action 116, action 120, action 122). Ultimately the generation of hardware code for a particular sub-function may reach the fail state 110 if the errors cannot be ameliorated. To overcome the limitations of such conventional approaches, the present disclosure introduces embodiments of a structured agent-based framework.

Herein, a “model” refers to a large language model instance operated with a system generated or user generated prompt. An “agent” refers to a model specialized for a specific task via a dedicated prompt and input/output format (e.g., “Python coding agent”). A “component” refers to a cooperating set of agents that together implement a macro stage of the pipeline (e.g., “progressive coding and prompt optimization component”). Unless noted, agents within a component may share the same underlying model operated with different prompts and context.

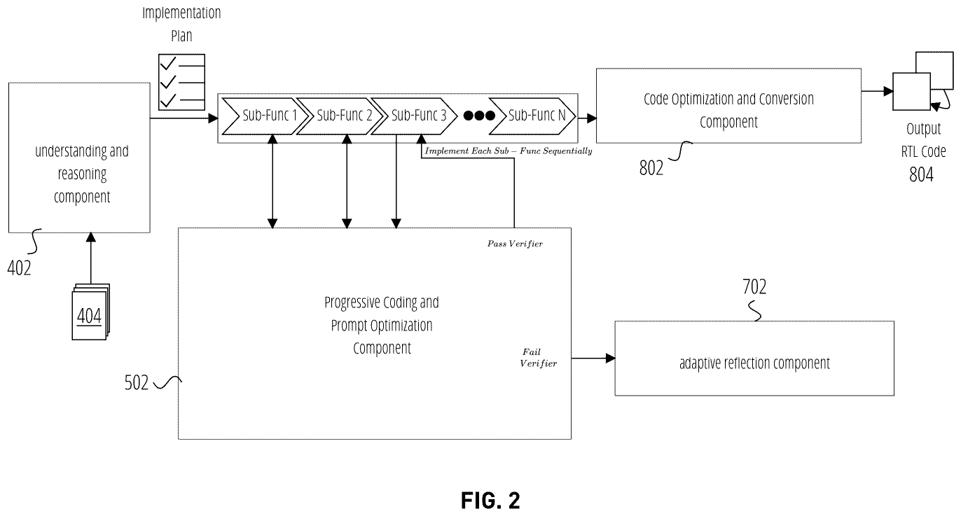

FIG. 2 depicts an embodiment of a system configured to transform complex, unstructured hardware specification documents into register-transfer level (RTL) code. The system comprise four macro components that cooperate to progressively interpret the hardware specification document, generate candidate implementations, detect and correct errors, and transform verified design plans into synthesizable RTL.

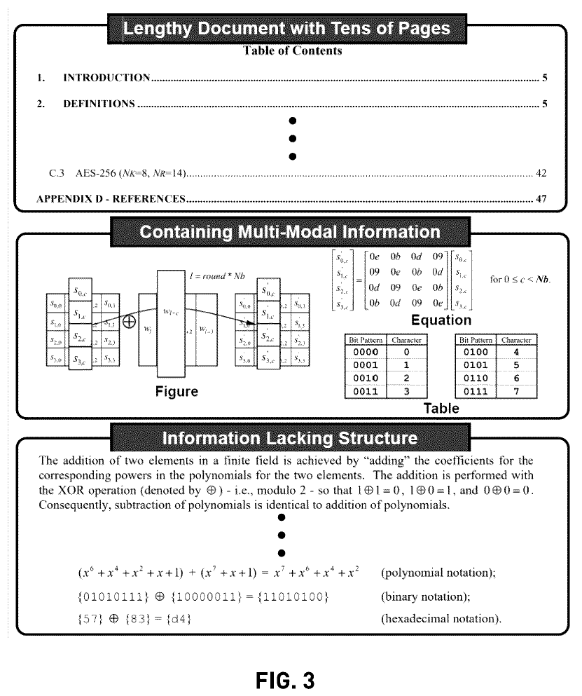

The macro components comprise:
1. An iterative understanding and reasoning component 402 that derives a structured implementation plan from an original hardware specification document 404. An exemplary hardware specification document 404 is depicted in part in FIG. 3;
2. A progressive coding and prompt optimization component 502 that generates an implementation of each sub-function of the implementation plan using staged code generation and verifier-guided refinements;
3. An adaptive reflection component 702 that analyzes design failures and selects corrective actions to ensure implementation robustness; and
4. A code optimization and conversion component 802 that reformats verified implementations for compatibility with high-level synthesis tools and outputs the final RTL code 804.

Each component may be implemented by the same large language model operated with different system (role-configuring) and user (action configuring) prompts at different stages. Each component may be configured as multiple cooperating agents.

The hardware specification document 404 may be a multimodal (mixed media) input comprising a variety of encodings including text, tables, equations, and figures. Equations and tables may be normalized into machine-readable formats such as LaTeX or markdown and figures may be replaced with placeholders accompanied by corresponding image data.

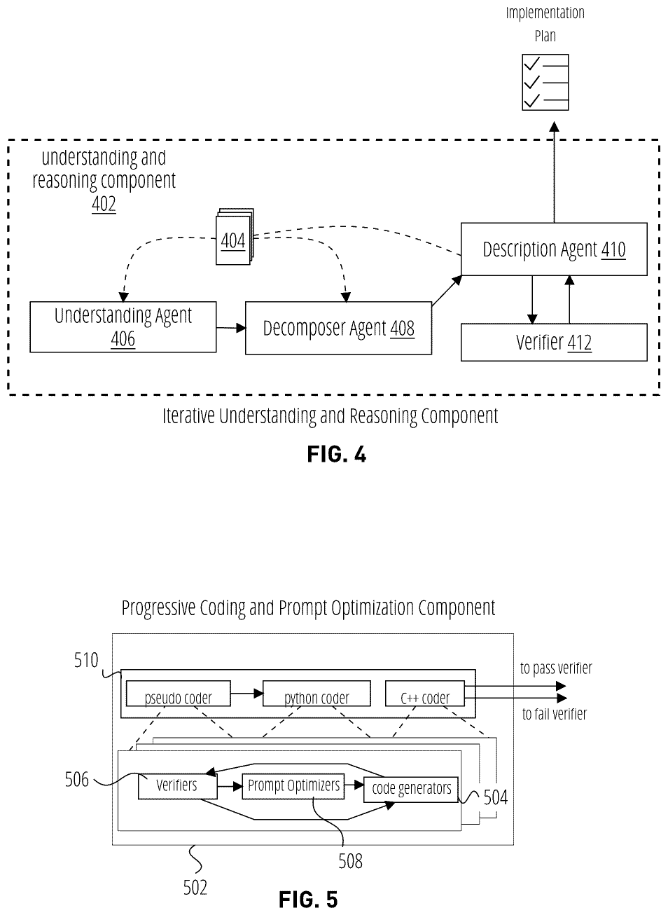

FIG. 4 depicts an embodiment of an iterative understanding and reasoning component 402 configured to transform a hardware specification document 404 into a structured, implementation-ready plan. This component comprises multiple cooperating agents (large language model configured with appropriate prompts for role and actions):
5. An understanding agent 406 configured to condense long-form specification content into concise section-level summaries;
6. A decomposer agent 408 configured to partition the overall functionality encoded in the hardware specification document 404 into into a sequenced set of sub-functions;
7. A description agent 410 configured to augment the sub-functions with details such as inputs, outputs, and intermediate constraints; and
8. A verifier agent 412 configured to review output of the description agent 410 and provide corrective feedback in an iterative manner until a complete, consistent implementation plan is produced.

FIG. 5 depicts an embodiment of a progressive coding and prompt optimization component 502 configured to receive an implementation plan from the understanding and reasoning component 402 and to generate executable code for each sub-function of the implementation plan in sequence.

The progressive coding and prompt optimization component 502 implements a staged generation pipeline (progressive coding), whereby at each stage, code is generated by a corresponding code generator 504 agent at progressively lower abstraction levels. A corresponding code verifier 506 agent validates the output of the code generator 504 at each level. Higher-level code is provided as a reference (e.g., context to the large language model) for generating lower-level code, improving correctness and consistency. For example, pseudocode generated by a pseudo-coding agent may guide Python code generation which in turn constrains C++ code generation.

Verification at each abstraction level may utilize:
9. Explicit test cases extracted from the hardware specification document 404;
10. Derived constraints from the structured sub-function description; and/or
11. Behavioral equivalence checks against higher-level code outputs.

This layered validation ensures that errors are detected early rather than only at the final stage of RTL conversion.

To enhance efficiency, the progressive coding and prompt optimization component 502 may implement a prompt optimizer 508 at each abstraction level. The prompt optimizer 508 monitors interactions between the code generator 504 and code verifier 506 agents, extracting patterns of repeated errors, and automatically refining subsequent prompts with targeted hints. This may reduce redundant iterations, lower computational overhead, and accelerate convergence to correct implementations.

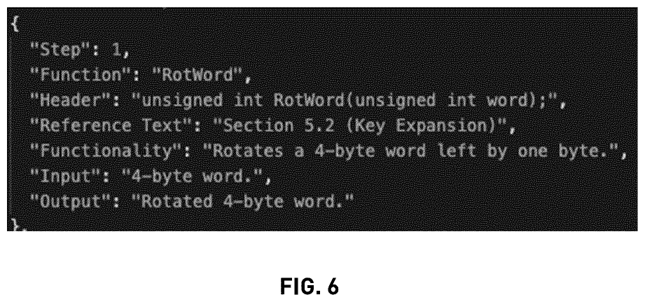

FIG. 6 depicts an exemplary implementation-plan entry schema consumed and transformed by the progressive coding and prompt optimization component 502. In one embodiment, each entry includes: subfn_id, inputs/outputs with types and shapes, constraints (timing, memory, constant-time), algorithm_steps, dependencies, and validation_hooks (references to spec anchors or known vectors). The progressive coding and prompt optimization component 502 inputs this schema and emits outputs {pseudocode, python, C++} with traceable provenance.

To improve determinism and reuse, outputs from each stage may be cached with metadata such as: {model version, temperature, prompt hash, parent_artifact_ids}. Here, parent_artifact_ids represents outputs from higher-level code agents 510.

The code verifiers 506 may request cross-level consistency checks that execute higher-level code (e.g., Python) as cross-check against lower-level outputs (e.g., C++). Inputs to the code verifiers 506 therefore may include the plan entry, higher-level outputs from the code agents 510 (if available), and the candidate code from the current coding level. Outputs of the code verifiers 506 may include a structured verdict and minimal failing counterexamples.

The prompt optimizers 508 maintain a compact, per-stage rule store distilled from prior failures. The prompt optimizers 508 may be invoked after a configured number K of consecutive rejections from the code verifier 506 for the same sub-function and stage, or immediately when a rejection from the code verifier 506 cites a known pattern (e.g., “shape/length mismatch”, “undefined parameter”). The prompt optimizer 508 may emit short, model-agnostic hints that are appended to subsequent code agent 510 prompts and are scoped to the current sub-function unless marked reusable across dependencies.

For example, at the Python stage, the code verifier 506 may execute specification-derived test cases and detects incorrect results (e.g., multiply (0x53, 0xCA) returning 0x00 instead of the expected 0x01). The prompt optimizer 508 for the Python stage may append corrective rules (e.g., “ensure modular reduction using irreducible polynomial 0x11b at every iteration; validate highest-bit position logic”) to the code agent 510 prompt. If repeated attempts fail, the adaptive reflection component 702 may escalate by re-routing to the description agent 410 to regenerate a corrected function specification, ensuring downstream code aligns with the algorithmic intent of the original document.

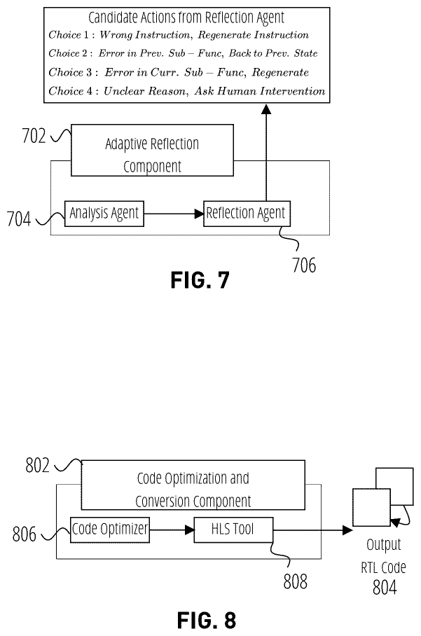

FIG. 7 depicts an adaptive reflection component 702 in one embodiment. This component operates when verification of a sub-function by the progressive coding and prompt optimization component 502 fails after repeated attempts despite prompt optimization (e.g., N attempts configurable per abstraction level). The adaptive reflection component 702 comprises an analysis agent 704 configured to review the system's generation trajectory and identify potential error sources, and a reflection agent 706 that identifies potential corrective actions. Candidate corrective actions may include:
12. Regenerating instructions for the current sub-function;
13. Revisiting and revising earlier sub-functions;
14. Restarting generation for the current sub-function with targeted guidance; or
15. Escalating unresolved issues for human intervention.

By adaptively selecting among these strategies, the system may prevent error propagation and improve overall design robustness.

The adaptive reflection component 702 utilizes the failing artifacts (prompts, code, logs), the structured sub-function description, and cross-level signals (e.g., pseudocode vs. Python outputs) to score likely error sources and select a corrective action without changing global system state unless explicitly instructed to do so.

FIG. 8 depicts a code optimization and conversion component 802 in one embodiment. Once all sub-functions of the implementation plan have been successfully implemented and verified by the progressive coding and prompt optimization component 502, the code optimization and conversion component 802 is invoked to prepare the output for synthesis.

The code optimization and conversion component 802 comprises a code optimizer 806 agent configured to reformat and adapt the lowest-level of generated code (e.g., C++) to conform to the input requirements of a commercial high-level synthesis (HLS) tool, such as Stratus HLS. Adaptations made by the code optimizer 806 may include enforcing static memory allocation, normalizing data types, and restructuring control flow.

The optimized code is then passed to an HLS tool 808 that converts the high-level design into register-transfer level (RTL) code 804. The resulting RTL code 804 is suitable for downstream simulation, verification, and integration into conventional hardware design.

Table 1 under the heading Exemplary Large language model Configuration Settings depicts exemplary settings to configure a large language model to operate as the system agents.

The system unifies document understanding, code generation, error correction, and hardware synthesis into a single end-to-end pipeline. Unlike conventional approaches, which rely heavily on human engineers for decomposition, prompt design, and iterative debugging, the system automates these processes through coordinated agents operating within structured components.

The mechanisms disclosed herein may be implemented in and/or by computing devices utilizing one or more graphic processing unit (GPU) and/or general purpose data processor (e.g., a “central processing unit” or CPU). A graphics processing unit may be a standalone chip or package, or may comprise graphics processing circuitry integrated with a central processing unit. Exemplary architectures will now be described that may be configured to implement the mechanisms disclosed herein, for example with machine-readable instructions stored in a media (e.g., main memory 1404) that are applied to one or more CPU (e.g., central processing unit 1302) and/or GPU (e.g., parallel processing unit 902/parallel processing module 1306).

The following description may use certain acronyms and abbreviations as follows:
“DPC” refers to a “data processing cluster”;
“GPC” refers to a “general processing cluster”;
“I/O” refers to a “input/output”;
“L1 cache” refers to “level one cache”;
“L2 cache” refers to “level two cache”;
“LSU” refers to a “load/store unit”;
“MMU” refers to a “memory management unit”;
“MPC” refers to an “M-pipe controller”;
“PPU” refers to a “parallel processing unit”;
“PROP” refers to a “pre-raster operations unit”;
“ROP” refers to a “raster operations”;
“SFU” refers to a “special function unit”;
“SM” refers to a “streaming multiprocessor”;
“Viewport SCC” refers to “viewport scale, cull, and clip”;
“WDX” refers to a “work distribution crossbar”; and
“XBar” refers to a “crossbar”.

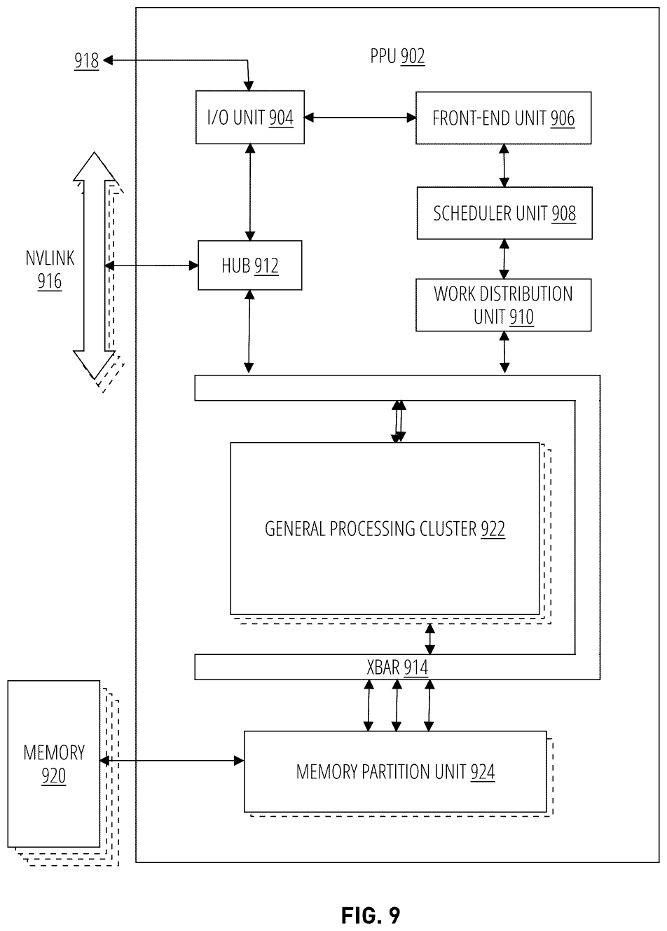

FIG. 9 depicts a parallel processing unit 902, in accordance with an embodiment. In an embodiment, the parallel processing unit 902 is a multi-threaded processor that is implemented on one or more integrated circuit devices. The parallel processing unit 902 is a latency hiding architecture designed to process many threads in parallel. A thread (e.g., a thread of execution) is an instantiation of a set of instructions configured to be executed by the parallel processing unit 902. In an embodiment, the parallel processing unit 902 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the parallel processing unit 902 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more parallel processing unit 902 modules may be configured to accelerate thousands of High Performance Computing (HPC), data center, and machine learning applications. The parallel processing unit 902 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 9, the parallel processing unit 902 includes an I/O unit 904, a front-end unit 906, a scheduler unit 908, a work distribution unit 910, a hub 912, a crossbar 914, one or more general processing cluster 922 modules, and one or more memory partition unit 924 modules. The parallel processing unit 902 may be connected to a host processor or other parallel processing unit 902 modules via one or more high-speed NVLink 916 interconnects. The parallel processing unit 902 may be connected to a host processor or other peripheral devices via an interconnect 918. The parallel processing unit 902 may also be connected to a local memory comprising a number of memory 920 devices. In an embodiment, the local memory may comprise a number of dynamic random access memory (DRAM) devices. The DRAM devices may be configured as a high-bandwidth memory (HBM) subsystem, with multiple DRAM dies stacked within each device. The memory 920 may comprise logic to configure the parallel processing unit 902 to carry out aspects of the techniques disclosed herein.

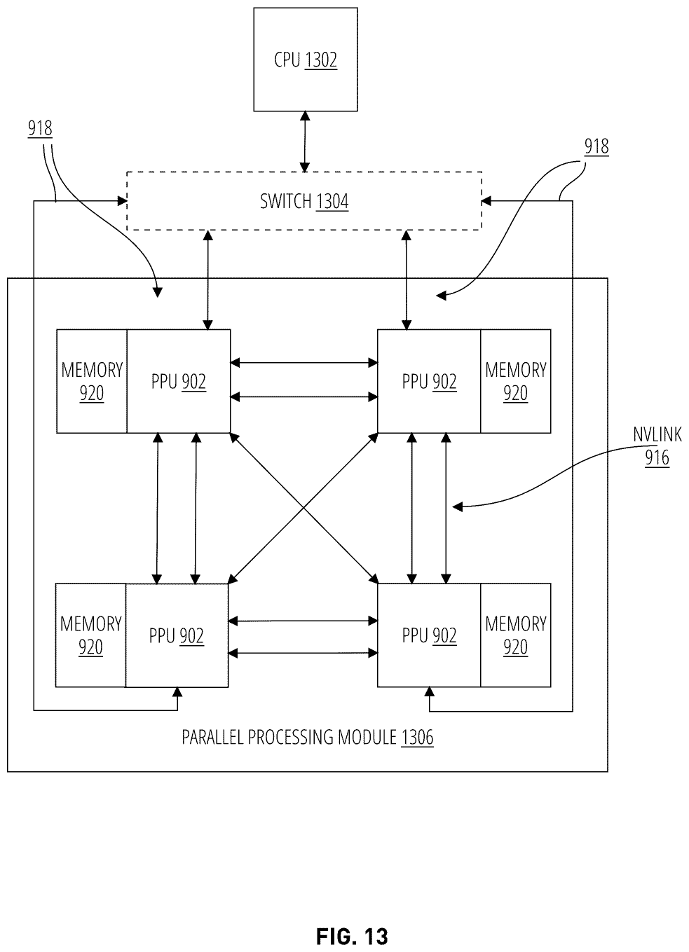

The NVLink 916 interconnect enables systems to scale and include one or more parallel processing unit 902 modules combined with one or more CPUs, supports cache coherence between the parallel processing unit 902 modules and CPUs, and CPU mastering. Data and/or commands may be transmitted by the NVLink 916 through the hub 912 to/from other units of the parallel processing unit 902 such as one or more copy engines, a video encoder, a video decoder, a power management unit, etc. (not explicitly shown). The NVLink 916 is described in more detail in conjunction with FIG. 13.

The I/O unit 904 is configured to transmit and receive communications (e.g., commands, data, etc.) from a host processor (not shown) over the interconnect 918. The I/O unit 904 may communicate with the host processor directly via the interconnect 918 or through one or more intermediate devices such as a memory bridge. In an embodiment, the I/O unit 904 may communicate with one or more other processors, such as one or more parallel processing unit 902 modules via the interconnect 918. In an embodiment, the I/O unit 904 implements a Peripheral Component Interconnect Express (PCIe) interface for communications over a PCIe bus and the interconnect 918 is a PCIe bus. In alternative embodiments, the I/O unit 904 may implement other types of well-known interfaces for communicating with external devices.

The I/O unit 904 decodes packets received via the interconnect 918. In an embodiment, the packets represent commands configured to cause the parallel processing unit 902 to perform various operations. The I/O unit 904 transmits the decoded commands to various other units of the parallel processing unit 902 as the commands may specify. For example, some commands may be transmitted to the front-end unit 906. Other commands may be transmitted to the hub 912 or other units of the parallel processing unit 902 such as one or more copy engines, a video encoder, a video decoder, a power management unit, etc. (not explicitly shown). In other words, the I/O unit 904 is configured to route communications between and among the various logical units of the parallel processing unit 902.

In an embodiment, a program executed by the host processor encodes a command stream in a buffer that provides workloads to the parallel processing unit 902 for processing. A workload may comprise several instructions and data to be processed by those instructions. The buffer is a region in a memory that is accessible (e.g., read/write) by both the host processor and the parallel processing unit 902. For example, the I/O unit 904 may be configured to access the buffer in a system memory connected to the interconnect 918 via memory requests transmitted over the interconnect 918. In an embodiment, the host processor writes the command stream to the buffer and then transmits a pointer to the start of the command stream to the parallel processing unit 902. The front-end unit 906 receives pointers to one or more command streams. The front-end unit 906 manages the one or more streams, reading commands from the streams and forwarding commands to the various units of the parallel processing unit 902.

The front-end unit 906 is coupled to a scheduler unit 908 that configures the various general processing cluster 922 modules to process tasks defined by the one or more streams. The scheduler unit 908 is configured to track state information related to the various tasks managed by the scheduler unit 908. The state may indicate which general processing cluster 922 a task is assigned to, whether the task is active or inactive, a priority level associated with the task, and so forth. The scheduler unit 908 manages the execution of a plurality of tasks on the one or more general processing cluster 922 modules.

The scheduler unit 908 is coupled to a work distribution unit 910 that is configured to dispatch tasks for execution on the general processing cluster 922 modules. The work distribution unit 910 may track a number of scheduled tasks received from the scheduler unit 908. In an embodiment, the work distribution unit 910 manages a pending task pool and an active task pool for each of the general processing cluster 922 modules. The pending task pool may comprise a number of slots (e.g., 32 slots) that contain tasks assigned to be processed by a particular general processing cluster 922. The active task pool may comprise a number of slots (e.g., 4 slots) for tasks that are actively being processed by the general processing cluster 922 modules. As a general processing cluster 922 finishes the execution of a task, that task is evicted from the active task pool for the general processing cluster 922 and one of the other tasks from the pending task pool is selected and scheduled for execution on the general processing cluster 922. If an active task has been idle on the general processing cluster 922, such as while waiting for a data dependency to be resolved, then the active task may be evicted from the general processing cluster 922 and returned to the pending task pool while another task in the pending task pool is selected and scheduled for execution on the general processing cluster 922.

The work distribution unit 910 communicates with the one or more general processing cluster 922 modules via crossbar 914. The crossbar 914 is an interconnect network that couples many of the units of the parallel processing unit 902 to other units of the parallel processing unit 902. For example, the crossbar 914 may be configured to couple the work distribution unit 910 to a particular general processing cluster 922. Although not shown explicitly, one or more other units of the parallel processing unit 902 may also be connected to the crossbar 914 via the hub 912.

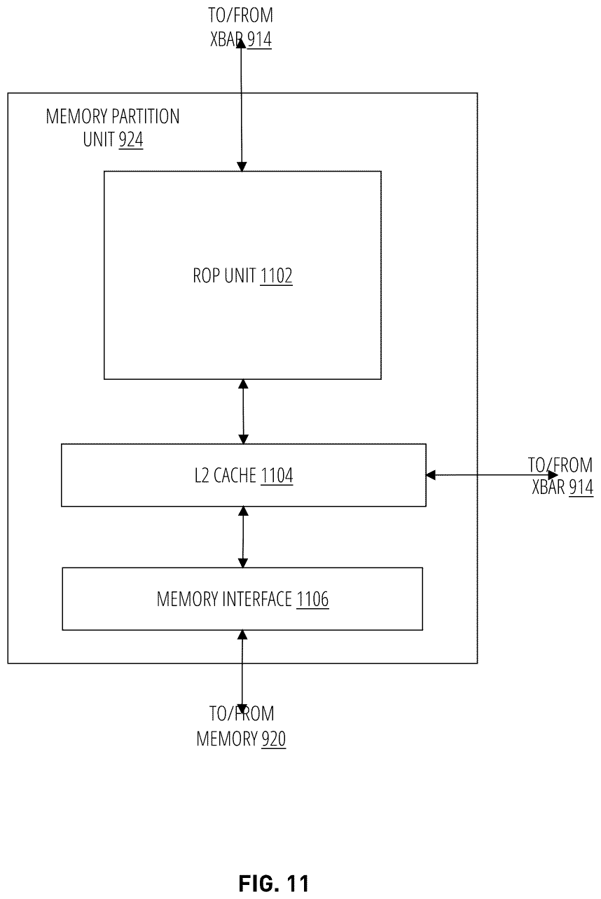

The tasks are managed by the scheduler unit 908 and dispatched to a general processing cluster 922 by the work distribution unit 910. The general processing cluster 922 is configured to process the task and generate results. The results may be consumed by other tasks within the general processing cluster 922, routed to a different general processing cluster 922 via the crossbar 914, or stored in the memory 920. The results can be written to the memory 920 via the memory partition unit 924 modules, which implement a memory interface for reading and writing data to/from the memory 920. The results can be transmitted to another parallel processing unit 902 or CPU via the NVLink 916. In an embodiment, the parallel processing unit 902 includes a number U of memory partition unit 924 modules that is equal to the number of separate and distinct memory 920 devices coupled to the parallel processing unit 902. A memory partition unit 924 will be described in more detail below in conjunction with FIG. 11.

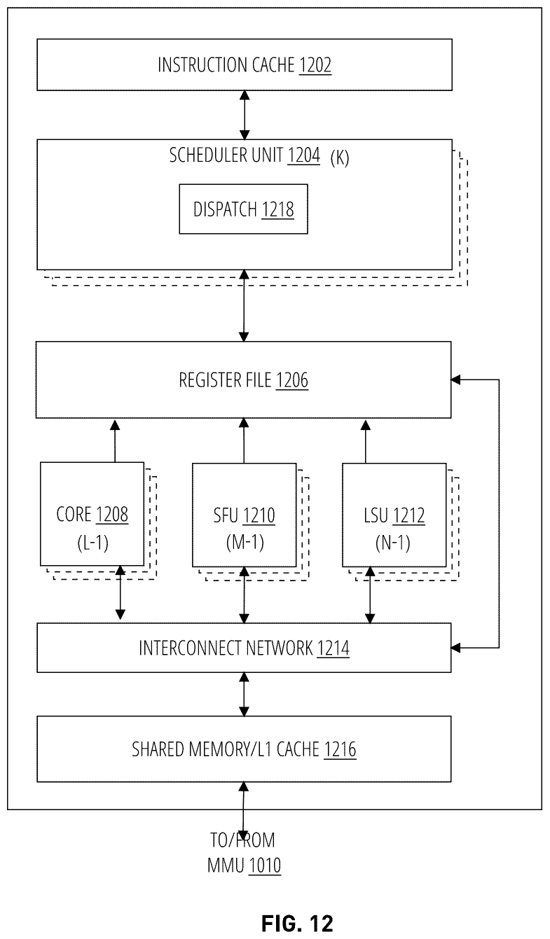

In an embodiment, a host processor executes a driver kernel that implements an application programming interface (API) that enables one or more applications executing on the host processor to schedule operations for execution on the parallel processing unit 902. In an embodiment, multiple compute applications are simultaneously executed by the parallel processing unit 902 and the parallel processing unit 902 provides isolation, quality of service (QoS), and independent address spaces for the multiple compute applications. An application may generate instructions (e.g., API calls) that cause the driver kernel to generate one or more tasks for execution by the parallel processing unit 902. The driver kernel outputs tasks to one or more streams being processed by the parallel processing unit 902. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 12.

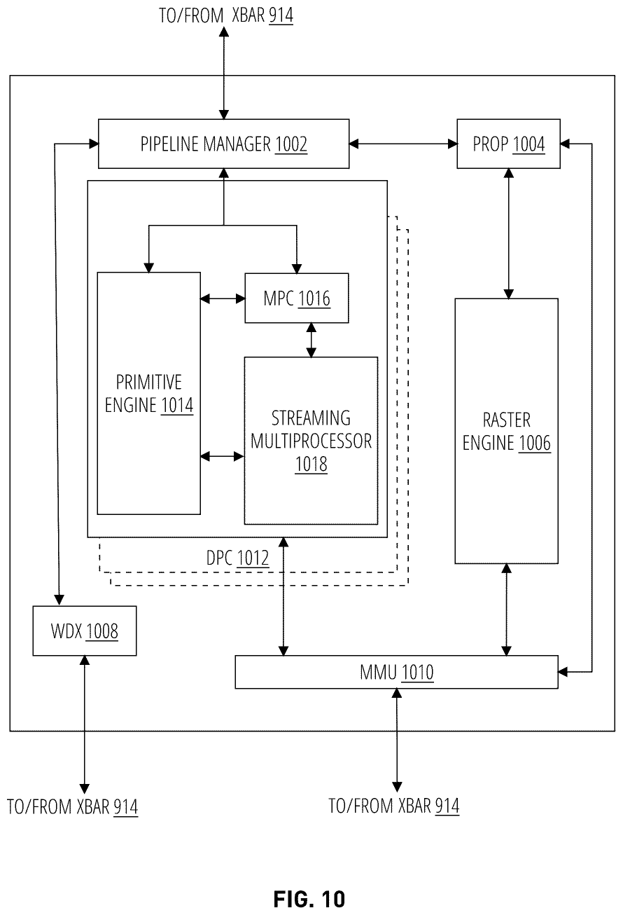

FIG. 10 depicts a general processing cluster 922 of the parallel processing unit 902 of FIG. 9, in accordance with an embodiment. As shown in FIG. 10, each general processing cluster 922 includes a number of hardware units for processing tasks. In an embodiment, each general processing cluster 922 includes a pipeline manager 1002, a pre-raster operations unit 1004, a raster engine 1006, a work distribution crossbar 1008, a memory management unit 1010, and one or more data processing cluster 1012. It will be appreciated that the general processing cluster 922 of FIG. 10 may include other hardware units in lieu of or in addition to the units shown in FIG. 10.

In an embodiment, the operation of the general processing cluster 922 is controlled by the pipeline manager 1002. The pipeline manager 1002 manages the configuration of the one or more data processing cluster 1012 modules for processing tasks allocated to the general processing cluster 922. In an embodiment, the pipeline manager 1002 may configure at least one of the one or more data processing cluster 1012 modules to implement at least a portion of a graphics rendering pipeline. For example, a data processing cluster 1012 may be configured to execute a vertex shader program on the programmable streaming multiprocessor 1018. The pipeline manager 1002 may also be configured to route packets received from the work distribution unit 910 to the appropriate logical units within the general processing cluster 922. For example, some packets may be routed to fixed function hardware units in the pre-raster operations unit 1004 and/or raster engine 1006 while other packets may be routed to the data processing cluster 1012 modules for processing by the primitive engine 1014 or the streaming multiprocessor 1018. In an embodiment, the pipeline manager 1002 may configure at least one of the one or more data processing cluster 1012 modules to implement a neural network model and/or a computing pipeline.

The pre-raster operations unit 1004 is configured to route data generated by the raster engine 1006 and the data processing cluster 1012 modules to a Raster Operations (ROP) unit, described in more detail in conjunction with FIG. 11. The pre-raster operations unit 1004 may also be configured to perform optimizations for color blending, organize pixel data, perform address translations, and the like.

The raster engine 1006 includes a number of fixed function hardware units configured to perform various raster operations. In an embodiment, the raster engine 1006 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x, y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 1006 comprises fragments to be processed, for example, by a fragment shader implemented within a data processing cluster 1012.

Each data processing cluster 1012 included in the general processing cluster 922 includes an M-pipe controller 1016, a primitive engine 1014, and one or more streaming multiprocessor 1018 modules. The M-pipe controller 1016 controls the operation of the data processing cluster 1012, routing packets received from the pipeline manager 1002 to the appropriate units in the data processing cluster 1012. For example, packets associated with a vertex may be routed to the primitive engine 1014, which is configured to fetch vertex attributes associated with the vertex from the memory 920. In contrast, packets associated with a shader program may be transmitted to the streaming multiprocessor 1018.

The streaming multiprocessor 1018 comprises a programmable streaming processor that is configured to process tasks represented by a number of threads. Each streaming multiprocessor 1018 is multi-threaded and configured to execute a plurality of threads (e.g., 32 threads) from a particular group of threads concurrently. In an embodiment, the streaming multiprocessor 1018 implements a Single-Instruction, Multiple-Data (SIMD) architecture where each thread in a group of threads (e.g., a warp) is configured to process a different set of data based on the same set of instructions. All threads in the group of threads execute the same instructions. In another embodiment, the streaming multiprocessor 1018 implements a Single-Instruction, Multiple Thread (SIMT) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The streaming multiprocessor 1018 will be described in more detail below in conjunction with FIG. 12.

The memory management unit 1010 provides an interface between the general processing cluster 922 and the memory partition unit 924. The memory management unit 1010 may provide translation of virtual addresses into physical addresses, memory protection, and arbitration of memory requests. In an embodiment, the memory management unit 1010 provides one or more translation lookaside buffers (TLBs) for performing translation of virtual addresses into physical addresses in the memory 920.

FIG. 11 depicts a memory partition unit 924 of the parallel processing unit 902 of FIG. 9, in accordance with an embodiment. As shown in FIG. 11, the memory partition unit 924 includes a raster operations unit 1102, a level two cache 1104, and a memory interface 1106. The memory interface 1106 is coupled to the memory 920. Memory interface 1106 may implement 32, 64, 128, 1024-bit data buses, or the like, for high-speed data transfer. In an embodiment, the parallel processing unit 902 incorporates U memory interface 1106 modules, one memory interface 1106 per pair of memory partition unit 924 modules, where each pair of memory partition unit 924 modules is connected to a corresponding memory 920 device. For example, parallel processing unit 902 may be connected to up to Y memory 920 devices, such as high bandwidth memory stacks or graphics double-data-rate, version 5, synchronous dynamic random access memory, or other types of persistent storage.

In an embodiment, the memory interface 1106 implements an HBM2 memory interface and Y equals half U. In an embodiment, the HBM2 memory stacks are located on the same physical package as the parallel processing unit 902, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 920 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where parallel processing unit 902 modules process very large datasets and/or run applications for extended periods.

In an embodiment, the parallel processing unit 902 implements a multi-level memory hierarchy. In an embodiment, the memory partition unit 924 supports a unified memory to provide a single unified virtual address space for CPU and parallel processing unit 902 memory, enabling data sharing between virtual memory systems. In an embodiment the frequency of accesses by a parallel processing unit 902 to memory located on other processors is traced to ensure that memory pages are moved to the physical memory of the parallel processing unit 902 that is accessing the pages more frequently. In an embodiment, the NVLink 916 supports address translation services allowing the parallel processing unit 902 to directly access a CPU's page tables and providing full access to CPU memory by the parallel processing unit 902.

In an embodiment, copy engines transfer data between multiple parallel processing unit 902 modules or between parallel processing unit 902 modules and CPUs. The copy engines can generate page faults for addresses that are not mapped into the page tables. The memory partition unit 924 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 920 or other system memory may be fetched by the memory partition unit 924 and stored in the level two cache 1104, which is located on-chip and is shared between the various general processing cluster 922 modules. As shown, each memory partition unit 924 includes a portion of the level two cache 1104 associated with a corresponding memory 920 device. Lower level caches may then be implemented in various units within the general processing cluster 922 modules. For example, each of the streaming multiprocessor 1018 modules may implement an L1 cache. The L1 cache is private memory that is dedicated to a particular streaming multiprocessor 1018. Data from the level two cache 1104 may be fetched and stored in each of the L1 caches for processing in the functional units of the streaming multiprocessor 1018 modules. The level two cache 1104 is coupled to the memory interface 1106 and the crossbar 914.

The raster operations unit 1102 performs graphics raster operations related to pixel color, such as color compression, pixel blending, and the like. The raster operations unit 1102 also implements depth testing in conjunction with the raster engine 1006, receiving a depth for a sample location associated with a pixel fragment from the culling engine of the raster engine 1006. The depth is tested against a corresponding depth in a depth buffer for a sample location associated with the fragment. If the fragment passes the depth test for the sample location, then the raster operations unit 1102 updates the depth buffer and transmits a result of the depth test to the raster engine 1006. It will be appreciated that the number of partition memory partition unit 924 modules may be different than the number of general processing cluster 922 modules and, therefore, each raster operations unit 1102 may be coupled to each of the general processing cluster 922 modules. The raster operations unit 1102 tracks packets received from the different general processing cluster 922 modules and determines which general processing cluster 1 that a result generated by the raster operations unit 1102 is routed to through the crossbar 914. Although the raster operations unit 1102 is included within the memory partition unit 924 in FIG. 11, in other embodiment, the raster operations unit 1102 may be outside of the memory partition unit 924. For example, the raster operations unit 1102 may reside in the general processing cluster 922 or another unit.

FIG. 12 illustrates the streaming multiprocessor 1018 of FIG. 10, in accordance with an embodiment. As shown in FIG. 12, the streaming multiprocessor 1018 includes an instruction cache 1202, one or more scheduler unit 1204 modules (e.g., such as scheduler unit 908), a register file 1206, one or more processing core 1208 modules, one or more special function unit 1210 modules, one or more load/store unit 1212 modules, an interconnect network 1214, and a shared memory/L1 cache 1216.

As described above, the work distribution unit 910 dispatches tasks for execution on the general processing cluster 922 modules of the parallel processing unit 902. The tasks are allocated to a particular data processing cluster 1012 within a general processing cluster 922 and, if the task is associated with a shader program, the task may be allocated to a streaming multiprocessor 1018. The scheduler unit 908 receives the tasks from the work distribution unit 910 and manages instruction scheduling for one or more thread blocks assigned to the streaming multiprocessor 1018. The scheduler unit 1204 schedules thread blocks for execution as warps of parallel threads, where each thread block is allocated at least one warp. In an embodiment, each warp executes 32 threads. The scheduler unit 1204 may manage a plurality of different thread blocks, allocating the warps to the different thread blocks and then dispatching instructions from the plurality of different cooperative groups to the various functional units (e.g., core 1208 modules, special function unit 1210 modules, and load/store unit 1212 modules) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch 1218 unit is configured within the scheduler unit 1204 to transmit instructions to one or more of the functional units. In one embodiment, the scheduler unit 1204 includes two dispatch 1218 units that enable two different instructions from the same warp to be dispatched during each clock cycle. In alternative embodiments, each scheduler unit 1204 may include a single dispatch 1218 unit or additional dispatch 1218 units.

Each streaming multiprocessor 1018 includes a register file 1206 that provides a set of registers for the functional units of the streaming multiprocessor 1018. In an embodiment, the register file 1206 is divided between each of the functional units such that each functional unit is allocated a dedicated portion of the register file 1206. In another embodiment, the register file 1206 is divided between the different warps being executed by the streaming multiprocessor 1018. The register file 1206 provides temporary storage for operands connected to the data paths of the functional units.

Each streaming multiprocessor 1018 comprises L processing core 1208 modules. In an embodiment, the streaming multiprocessor 1018 includes a large number (e.g., 128, etc.) of distinct processing core 1208 modules. Each core 1208 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the core 1208 modules include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the core 1208 modules. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A′B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each streaming multiprocessor 1018 also comprises M special function unit 1210 modules that perform special functions (e.g., attribute evaluation, reciprocal square root, and the like). In an embodiment, the special function unit 1210 modules may include a tree traversal unit configured to traverse a hierarchical tree data structure. In an embodiment, the special function unit 1210 modules may include texture unit configured to perform texture map filtering operations. In an embodiment, the texture units are configured to load texture maps (e.g., a 2D array of texels) from the memory 920 and sample the texture maps to produce sampled texture values for use in shader programs executed by the streaming multiprocessor 1018. In an embodiment, the texture maps are stored in the shared memory/L1 cache 1216. The texture units implement texture operations such as filtering operations using mip-maps (e.g., texture maps of varying levels of detail). In an embodiment, each streaming multiprocessor 1018 includes two texture units.

Each streaming multiprocessor 1018 also comprises N load/store unit 1212 modules that implement load and store operations between the shared memory/L1 cache 1216 and the register file 1206. Each streaming multiprocessor 1018 includes an interconnect network 1214 that connects each of the functional units to the register file 1206 and the load/store unit 1212 to the register file 1206 and shared memory/L1 cache 1216. In an embodiment, the interconnect network 1214 is a crossbar that can be configured to connect any of the functional units to any of the registers in the register file 1206 and connect the load/store unit 1212 modules to the register file 1206 and memory locations in shared memory/L1 cache 1216.

The shared memory/L1 cache 1216 is an array of on-chip memory that allows for data storage and communication between the streaming multiprocessor 1018 and the primitive engine 1014 and between threads in the streaming multiprocessor 1018. In an embodiment, the shared memory/L1 cache 1216 comprises 128 KB of storage capacity and is in the path from the streaming multiprocessor 1018 to the memory partition unit 924. The shared memory/L1 cache 1216 can be used to cache reads and writes. One or more of the shared memory/L1 cache 1216, level two cache 1104, and memory 920 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 1216 enables the shared memory/L1 cache 1216 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 9, are bypassed, creating a much simpler programming model. In the general purpose parallel computation configuration, the work distribution unit 910 assigns and distributes blocks of threads directly to the data processing cluster 1012 modules. The threads in a block execute the same program, using a unique thread ID in the calculation to ensure each thread generates unique results, using the streaming multiprocessor 1018 to execute the program and perform calculations, shared memory/L1 cache 1216 to communicate between threads, and the load/store unit 1212 to read and write global memory through the shared memory/L1 cache 1216 and the memory partition unit 924. When configured for general purpose parallel computation, the streaming multiprocessor 1018 can also write commands that the scheduler unit 908 can use to launch new work on the data processing cluster 1012 modules.

The parallel processing unit 902 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the parallel processing unit 902 is embodied on a single semiconductor substrate. In another embodiment, the parallel processing unit 902 is included in a system-on-a-chip (SoC) along with one or more other devices such as additional parallel processing unit 902 modules, the memory 920, a reduced instruction set computer (RISC) CPU, a memory management unit (MMU), a digital-to-analog converter (DAC), and the like.

In an embodiment, the parallel processing unit 902 may be included on a graphics card that includes one or more memory devices. The graphics card may be configured to interface with a PCIe slot on a motherboard of a desktop computer. In yet another embodiment, the parallel processing unit 902 may be an integrated graphics processing unit (iGPU) or parallel processor included in the chipset of the motherboard.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13 is a conceptual diagram of a processing system implemented using the parallel processing unit 902 of FIG. 9, in accordance with an embodiment. The processing system includes a central processing unit 1302, an switch 1304, and multiple parallel processing unit 902 modules each and respective memory 920 modules. The switch 1304 is depicted with dashed lines, indicating that it is optional in some embodiments.

The NVLink 916 provides high-speed communication links between each of the parallel processing unit 902 modules. Although a particular number of NVLink 916 and interconnect 918 connections are illustrated in FIG. 13, the number of connections to each parallel processing unit 902 and the central processing unit 1302 may vary. The switch 1304 interfaces between the interconnect 918 and the central processing unit 1302. The parallel processing unit 902 modules, memory 920 modules, and NVLink 916 connections may be situated on a single semiconductor platform to form a parallel processing module 1306. In an embodiment, the switch 1304 supports two or more protocols to interface between various different connections and/or links.

In another embodiment (not shown), the NVLink 916 provides one or more high-speed communication links between each of the parallel processing unit modules (parallel processing unit 902, parallel processing unit 902, parallel processing unit 902, and parallel processing unit 902) and the central processing unit 1302 and the switch 1304 (when present) interfaces between the interconnect 918 and each of the parallel processing unit modules. The parallel processing unit modules, memory 920 modules, and interconnect 918 may be situated on a single semiconductor platform to form a parallel processing module 1306. In yet another embodiment (not shown), the interconnect 918 provides one or more communication links between each of the parallel processing unit modules and the central processing unit 1302 and the switch 1304 interfaces between each of the parallel processing unit modules using the NVLink 916 to provide one or more high-speed communication links between the parallel processing unit modules. In another embodiment (not shown), the NVLink 916 provides one or more high-speed communication links between the parallel processing unit modules and the central processing unit 1302 through the switch 1304. In yet another embodiment (not shown), the interconnect 918 provides one or more communication links between each of the parallel processing unit modules directly. One or more of the NVLink 916 high-speed communication links may be implemented as a physical NVLink interconnect or either an on-chip or on-die interconnect using the same protocol as the NVLink 916.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1306 may be implemented as a circuit board substrate and each of the parallel processing unit modules and/or memory 920 modules may be packaged devices. In an embodiment, the central processing unit 1302, switch 1304, and the parallel processing module 1306 are situated on a single semiconductor platform.

In an embodiment, each parallel processing unit module includes six NVLink 916 interfaces (as shown in FIG. 13, five NVLink 916 interfaces are included for each parallel processing unit module). The NVLink 916 may be operated exclusively for PPU-to-PPU communication as shown in FIG. 13, or some combination of PPU-to-PPU and PPU-to-CPU, when the central processing unit 1302 also includes one or more NVLink 916 interfaces.

In an embodiment, the NVLink 916 allows direct load/store/atomic access from the central processing unit 1302 to each parallel processing unit module's memory 920. In an embodiment, the NVLink 916 supports coherency operations, allowing data read from the memory 920 modules to be stored in the cache hierarchy of the central processing unit 1302, reducing cache access latency for the central processing unit 1302. In an embodiment, the NVLink 916 includes support for Address Translation Services (ATS), enabling the parallel processing unit module to directly access page tables within the central processing unit 1302. One or more of the NVLink 916 may also be configured to operate in a low-power mode.

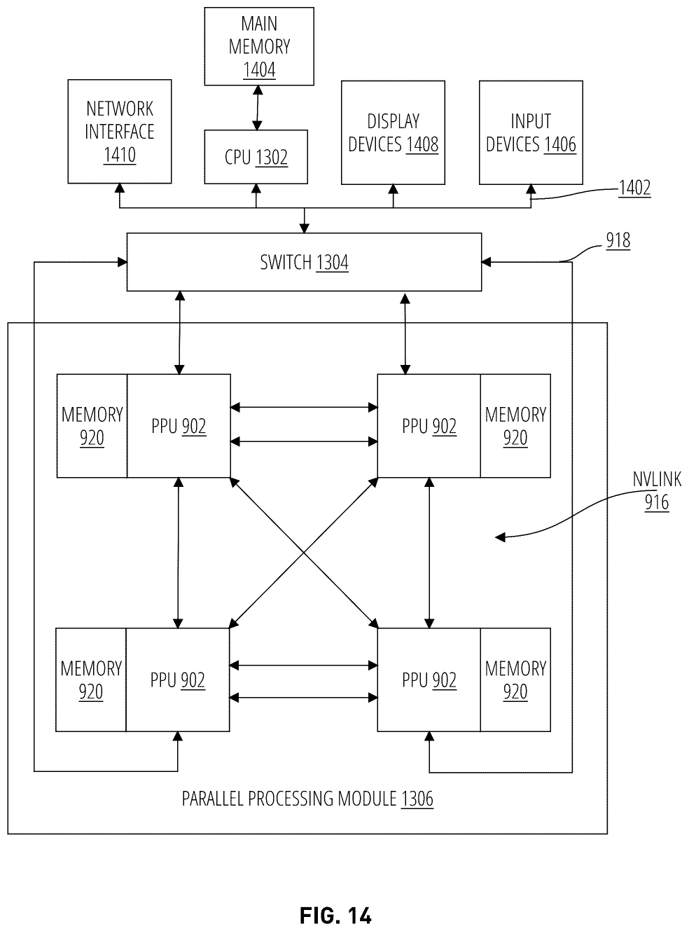

FIG. 14 depicts an exemplary processing system in which the various architecture and/or functionality of the various previous embodiments may be implemented. As shown, an exemplary processing system is provided including at least one central processing unit 1302 that is connected to a communications bus 1402. The communication communications bus 1402 may be implemented using any suitable protocol, such as PCI (Peripheral Component Interconnect), PCI-Express, AGP (Accelerated Graphics Port), HyperTransport, or any other bus or point-to-point communication protocol(s). The exemplary processing system also includes a main memory 1404. Control logic (software) and data are stored in the main memory 1404 which may take the form of random access memory (RAM). For simplicity of illustration, the main memory 1404 may be understood to comprise other forms of bulk memory, including non-volatile memory technologies.

The exemplary processing system also includes input devices 1406, the parallel processing module 1306, and display devices 1408, e.g. a conventional CRT (cathode ray tube), LCD (liquid crystal display), LED (light emitting diode), plasma display or the like. User input may be received from the input devices 1406, e.g., keyboard, mouse, touchpad, microphone, and the like. Each of the foregoing modules and/or devices may even be situated on a single semiconductor platform to form the exemplary processing system. Alternately, the various modules may also be situated separately or in various combinations of semiconductor platforms per the desires of the user.

Further, the exemplary processing system may be coupled to a network (e.g., a telecommunications network, local area network (LAN), wireless network, wide area network (WAN) such as the Internet, peer-to-peer network, cable network, or the like) through a network interface 1410 for communication purposes.

The exemplary processing system may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1404 and/or the secondary storage. Such computer programs, when executed, enable the exemplary processing system to perform various functions. The main memory 1404, the storage, and/or any other storage are possible examples of computer-readable media (volatile and/or non-volatile, depending on the implementation).

The architecture and/or functionality of the various previous figures may be implemented in the context of a general computer system, a circuit board system, a game console system dedicated for entertainment purposes, an application-specific system, and/or any other desired system. For example, the exemplary processing system may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### LISTING OF DRAWING ELEMENTS

102 action
104 decision
106 decision
108 action
110 fail state
112 success state
114 action
116 action
118 action
120 action
122 action
402 understanding and reasoning component
404 hardware specification document
406 understanding agent
408 decomposer agent
410 description agent
412 verifier agent
502 progressive coding and prompt optimization component
504 code generator
506 code verifier
508 prompt optimizer
510 code agents
702 adaptive reflection component
704 analysis agent
706 reflection agent
802 code optimization and conversion component
804 RTL code
806 code optimizer
808 HLS tool
902 parallel processing unit
904 I/O unit
906 front-end unit
908 scheduler unit
910 work distribution unit
912 hub
914 crossbar
916 NVLink
918 interconnect
920 memory
922 general processing cluster
924 memory partition unit
1002 pipeline manager
1004 pre-raster operations unit
1006 raster engine
1008 work distribution crossbar
1010 memory management unit
1012 data processing cluster
1014 primitive engine
1016 M-pipe controller
1018 streaming multiprocessor
1102 raster operations unit
1104 level two cache
1106 memory interface
1202 instruction cache
1204 scheduler unit
1206 register file
1208 core
1210 special function unit
1212 load/store unit
1214 interconnect network
1216 shared memory/L1 cache
1218 dispatch
1302 central processing unit
1304 switch
1306 parallel processing module
1402 communications bus
1404 main memory
1406 input devices
1408 display devices
1410 network interface

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system configured to transform a multimodal hardware specification document into register-transfer level (RTL) code, the system comprising:
an understanding and reasoning component configured to transform the hardware specification document into a structured implementation plan comprising a sequence of hardware functions;
a progressive coding and prompt optimization component configured to sequentially transform the hardware functions into low-level program code through a plurality of progressively lower-level code generation stages; and
a code optimization and conversion component configured to transform the low-level program code of the hardware functions into the RTL code.

2. The system of claim 1, further comprising:
an adaptive reflection component; and
the progressive coding and prompt optimization component configured to invoke the adaptive reflection component after one or more of (a) a configured number of verification errors for outputs of the code generation stages, and (b) specific verification errors for the outputs of the code generation stages.

3. The system of claim 1, wherein each component comprises a same large language model configured into task-specific agents with different role (system) and action (user) prompts.

4. The system of claim 3, wherein the understanding and reasoning component comprises:
an understanding agent configured to condense long-form content of the hardware specification document into section-level summaries;
a decomposer agent configured to partition the functionality encoded in the hardware specification document into the sequence of hardware functions;
a description agent configured to augment the hardware functions with details comprising inputs, outputs, and intermediate constraints; and
a verifier agent configured to review output of the description agent and generate corrective feedback to the description agent iteratively.

5. The system of claim 3, wherein each of the code generation stages comprises:
a code generator agent;
a verifier agent configured to receive code output from the code generator agent; and
a prompt optimizer for the code generator agent, the prompt optimizer configured to receive output of the verifier agent.

6. The system of claim 1, wherein the plurality of progressively lower-level code generation stages comprise a pseudocode stage, a Python stage, and a C++ stage.

7. The system of claim 1, wherein the code optimization and conversion component comprises:
a code optimizer configured to receive the low-level program code for the hardware functions; and
an high-level synthesis (HLS) tool configured to transform output of the code optimizer into the RTL code.

8. A process to transform a multimodal hardware specification document into register-transfer level (RTL) code, the process comprising:
configuring a large language model into multiple agents to transform the hardware specification document into a structured implementation plan comprising a sequence of hardware functions;
configuring the large language model to apply progressive coding and prompt optimization to sequentially transform the hardware functions into low-level program code through a plurality of progressively lower-level code generation stages; and
transforming the low-level program code of the hardware functions into the RTL code through a code optimizer and high-level synthesis tool.

9. The process of claim 8, further comprising:
invoking an adaptive reflection component after one or more of (a) a configured number of verification errors for outputs of the code generation stages, and (b) specific verification errors for the outputs of the code generation stages.

10. The process of claim 8, wherein the large language model is configured into task-specific agents by applying different role and action prompts to the large language model.

11. The process of claim 10, further comprising:
configuring the large language model to condense long-form content of the hardware specification document into section-level summaries;
configuring the large language model to partition the functionality encoded in the hardware specification document into the sequence of hardware functions;
configuring the large language model to augment the hardware functions with details comprising inputs, outputs, and intermediate constraints; and
configuring the large language model to review output of the description agent and generate corrective feedback to the description agent iteratively.

12. The process of claim 10, further comprising:
configuring the large language model to generate program code representing the hardware functions;
configuring the large language model to verify the program code; and
optimizing prompts to the large language model to generate the program code based on results of verifying the program code.

13. The process of claim 8, wherein the plurality of progressively lower-level code generation stages comprise a pseudocode stage, a Python stage, and a C++ stage.

14. A non-volatile media comprising machine-readable instructions that, when executed by one or more data processor of a computer system, configure the computer system to transform a multimodal hardware specification document into register-transfer level (RTL) code by:
configuring a large language model into multiple agents to transform the hardware specification document into a structured implementation plan comprising a sequence of hardware functions;
configuring the large language model to apply progressive coding and prompt optimization to sequentially transform the hardware functions into low-level program code through a plurality of progressively lower-level code generation stages; and
transforming the low-level program code of the hardware functions into the RTL code through a code optimizer and high-level synthesis tool.
